(19) United States
(12) Patent Application Publication
(10) Pub. No.: US 2003/0167150 A1
(43) Pub. Date: Sep. 4, 2003

(54) Data administration method in power-generating plant

(76) Inventors: Takao Shimura, Hitachi (JP); Masahiro Koike, Hitachi (JP); Satoshi Kanno, Hitachi (JP)

Correspondence Address: DICKSTEIN SHAPIRO MORIN & OSHINSKY LLP, 2101 L STREET NW, WASHINGTON, DC, 20037-1526, US

(21) Appl. No.: 10/373,780

(22) Filed: Feb. 27, 2003

(30) Foreign Application Priority Data
Mar. 1, 2002 (JP) 2002-055177

(51) Int. Cl. G06F 15/00

(52) U.S. Cl. 702/182

(57) ABSTRACT

A data administration method in a power-generating plant. Process data and operation history data of the power-generating plant are acquired from a power company; equipment-related data including the inspection data of the plant equipment is acquired from a plant maker; and these data are stored in a memory device in the state related to the plant equipment and/or inspection data every power-generating plant. The inspection data of the corresponding inspection data from among data stored in the memory device is extracted in response to inspection data requirement from the plant maker, and the extracted inspection data is provided to the plant maker. In response to the data requirement necessary for the evaluation of said plant configuration equipment from the plant maker, data necessary for the evaluation from among the data stored in the memory device, and the data necessary for the evaluation extracted is provided to the plant maker.

### BACKGROUND OF THE INVENTION

The present invention relates to an administration method for the inspection data of the configuration equipment of a plant and the operation data of a power-generating plant such as a nuclear power plant, a thermal power plant, etc. Also, this invention relates to a service business for administrating data in place of an electric power supplying company, a plant maker, etc.

The administration data (equipment management data) relating to the configuration equipment of a plant in a power-generating plant includes inspection data, operation data, etc. The inspection data within the equipment management data is administrated by the electric power company and the plant maker. On the other hand, the operation data is mainly administrated by the electric power company. Also, these equipment management data are independently administrated every power-generating plant. In case where the plant maker evaluates the goodness of the equipment, for example, by using the equipment management data, the plant maker acquires the operation data, etc. necessary for this evaluation from the electric power company, and performs the evaluation in consideration of also the inspection data.

The electric power company and the plant maker must administrate the equipment management data of the power-generating plant by themselves. The equipment management data during plant operation includes data relating to operation monitoring, inspection, periodic inspection, state monitoring, etc. The equipment management data during plant stoppage includes data relating to inspection, periodic inspection, repair, reconstruction, etc. Also, in the case of the nuclear power plant, the operation data includes the start and stop of a nuclear reactor, an operation cycle, water quality within the nuclear reactor, maintenance history, etc. For example, in the case of the maintenance history, data of parts replacement history, etc. is administrated every configuration in one plant. These data become huge amount of data, and a great amount of cost is needed for the data administration.

Especially, in the case of the nuclear power plant, the operation is determined repetition of the inspection (testing), the content of the inspection, judging standard, etc. on the basis of inspection standard during in-service inspection (ISI) of the equipment. That is, the inspection of the equipment is carried out in accordance with this inspection standard. Therefore, the equipment management data relating to the the configuration equipment of a plant must be administrated systematically in consideration of this inspection standard.

In actual condition, in case where the goodness of the equipment is evaluated, since the equipment management data is administrated individually every nuclear power plant, it is not easy to evaluate the goodness of the equipment systematically in consideration of also equipment management data in another nuclear power plant.

### SUMMARY OF THE INVENTION

An object of this invention is to provide a data administration method in an electric power generating plant in which it is possible to reduce the administration cost of the equipment management data in the electric power company and the plant maker, and it is possible to easily carried out the synthetic equipment goodness evaluation in consideration of also the equipment administration in another electric power-generating plant.

In the first invention achieving said object, data administration method in a power-generating plant in which process data and operation history data of the power-generating plant are acquired from an electric power company concluding a data administration contract; equipment-related data including the inspection data of the configuration equipment of a plant is acquired from a plant maker concluding a data administrating contract; and these data are stored in a memory device in the state related to said plant configuration equipment and/or inspection date every power-generating plant which said electric power company stores: the inspection data of the corresponding inspection data from among data stored in said memory device is extracted in response to inspection data requirement from said plant maker, and the extracted inspection data is provided to said plant maker: and in response to the data requirement necessary for the evaluation of said plant configuration equipment from said plant maker, data necessary for said evaluation from among the data stored in said memory device; and the data necessary for the evaluation which was extracted is provided to said plant maker. The process data, the operation history data, and the equipment related data are called as equipment management data.

In the second invention attaining said object, a data administration method in a power-generating plant is provided in which: process data and operation history data of the power-generating plant are acquired from an electric power company concluding a data administration contract; equipment-related data including the inspection data of the configuration equipment of a plant is acquired from a plant maker concluding a data administrating contract; and these data are stored in a memory device in the state related to said plant configuration equipment and/or inspection date every power-generating plant which said electric power company stores: the inspection data of the corresponding inspection data from among data stored in said memory device is extracted in response to inspection data requirement from said plant maker, and the extracted inspection data is provided to said plant maker; and in response to the data requirement necessary for the evaluation of said plant configuration equipment from said plant maker and said electric power generating company, data necessary for said evaluation from among the data stored in said memory device: and the data necessary for the evaluation which was extracted is provided to said plant maker and said electric power company.

In the third invention attaining said object, process data and operation history data of the power-generating plant, and equipment-related data including the inspection data of the configuration equipment of a plant are acquired from an electric power company concluding a data administration contract; equipment-related data including the inspection data of the configuration equipment of a plant is acquired from a plant maker concluding a data administrating contract: and these data are stored in a memory device in the state related to said plant configuration equipment and/or inspection date every power-generating plant which said electric power company stores: the inspection data of the corresponding inspection data from among data stored in said memory device is extracted in response to inspection data requirement from said plant maker, and the extracted inspection data is provided to said plant maker: and in response to the data requirement necessary for the evaluation of said plant configuration equipment from said plant maker, data necessary for said evaluation from among the data stored in said memory device; and the data necessary for the evaluation which was extracted is provided to said plant maker

In the forth invention attaining said object, a data administration method in a power-generating plant in which: process data and operation history data of the power-generating plant are acquired from an electric power company concluding a data administration contract; equipment-related data including the inspection data of the configuration equipment of a plant is acquired from a plant maker concluding a data administrating contract; and these data are stored in a memory device in the state related to said plant configuration equipment and/or inspection date every power-generating plant which said electric power company stores: the inspection data of the corresponding inspection data from among data stored in said memory device is extracted in response to inspection data requirement from said plant maker, and the extracted inspection data is provided to said electric power company: and in response to the data requirement necessary for the evaluation of said plant configuration equipment from said plant maker, data necessary for said evaluation from among the data stored in said memory device; and the data necessary for the evaluation which was extracted is provided to said plant maker.

In the fifth invention attaining said object: a data administration method in a power-generating plant is provided in which: process data and operation history data of the power-generating plant, and equipment-related data including the inspection data of the configuration equipment of a plant are acquired from a plant maker concluding a data administration contract; equipment-related data including the inspection data of the configuration equipment of a plant is acquired from a plant maker concluding a data administrating contract; and these data are stored in a memory device in the state related to said plant configuration equipment and/or inspection date every power-generating plant which said electric power company stores: the inspection data of the corresponding inspection data from among data stored in said memory device is extracted in response to inspection data requirement from said electric power company, and the extracted inspection data is provided to said electric power company; and in response to the data requirement necessary for the evaluation of said plant configuration equipment from said electric power company, data necessary for said evaluation from among the data stored in said memory device; and the data necessary for the evaluation which was extracted is provided to said electric power company.

### BRIEF DESCRIPTION OF THE DRAWING

FIG. 1 is a schematic system configuration view relating to the management business of the first embodiment according this invention.

FIG. 2 is a contract mode explanatory view relating to the management business of the first embodiment according to this invention.

FIG. 3 is an outline business flow view relating to the management business of the first embodiment according to this invention.

FIG. 4 is an outline business flow view relating to the management business of the second embodiment according to this invention.

FIG. 5 is an outline business flow view showing one example of a case in which an electric power company requests the cause investigation and measures of an advantage to a plant maker in the first embodiment.

FIG. 6 is an outline business flow view showing another example of a case in which an electric power company requests the cause investigation and measures of an advantage to a plant maker in the first embodiment.

FIG. 7 is a schematic system configuration view relating to the management business of the third embodiment according this invention.

FIG. 8 is an outline business flow view relating to the management business of the third embodiment according this invention.

FIG. 9 is a contract mode explanatory view relating to the management business of the forth embodiment according to this invention.

FIG. 10 is an outline business flow view relating to the management business of the forth embodiment according to this invention.

FIG. 11 is a contract mode explanatory view relating to the management business of the fifth embodiment according to this invention.

FIG. 12 is an outline business flow view relating to the management business of the fifth embodiment according to this invention

FIG. 13 is an outline configuration view of the equipment management database which the server of a data management company has and data discrimination means.

FIG. 14 is a data management table showing one example of management data.

FIG. 15 is a data management table showing maintenance history data.

### DETAILED DESCRIPTION OF THE PREFERRED EMBODIMENTS

(First Embodiment)

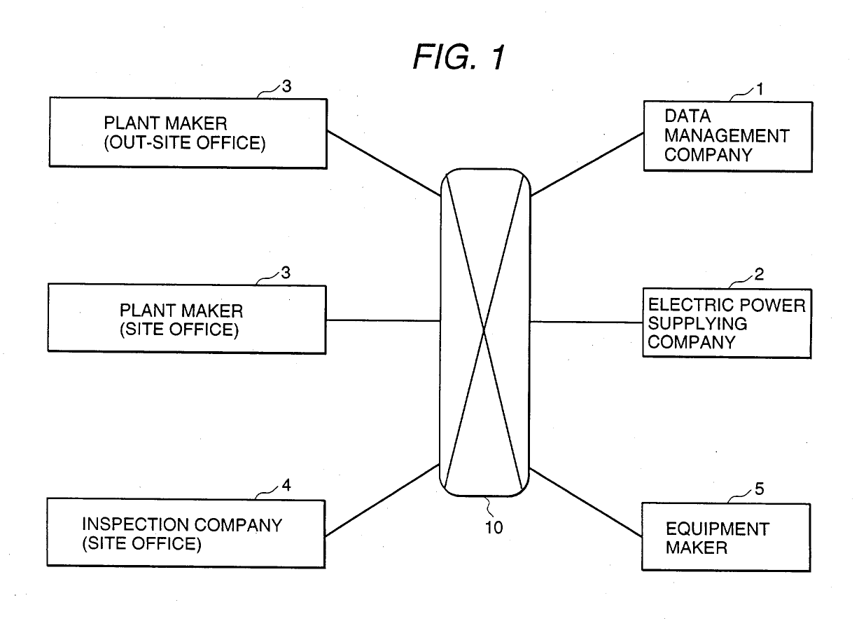

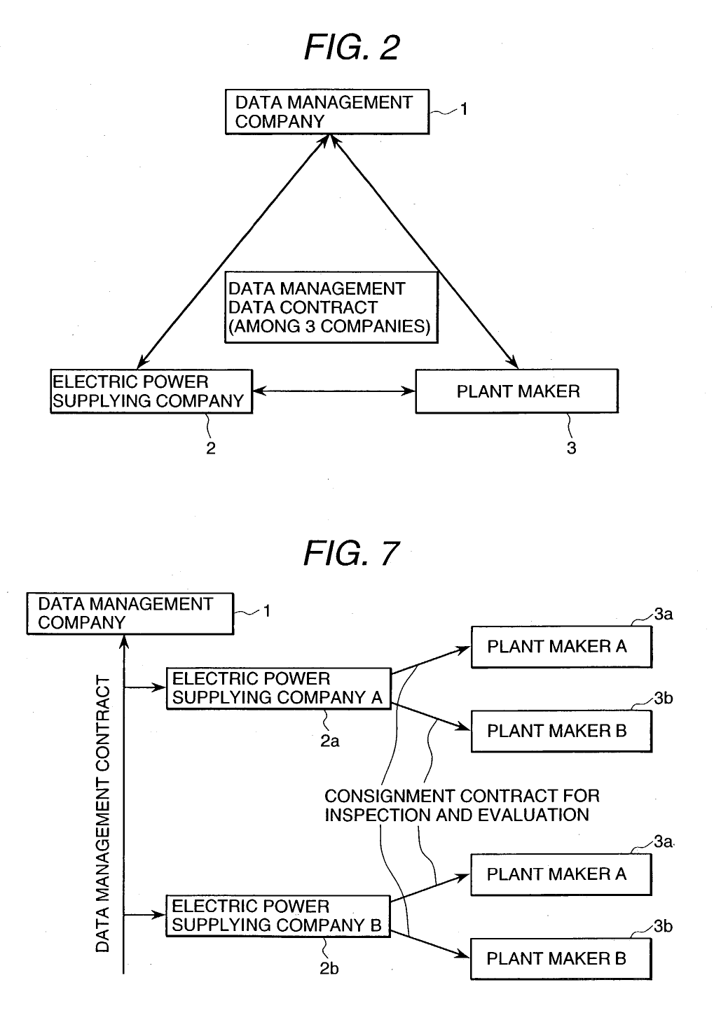

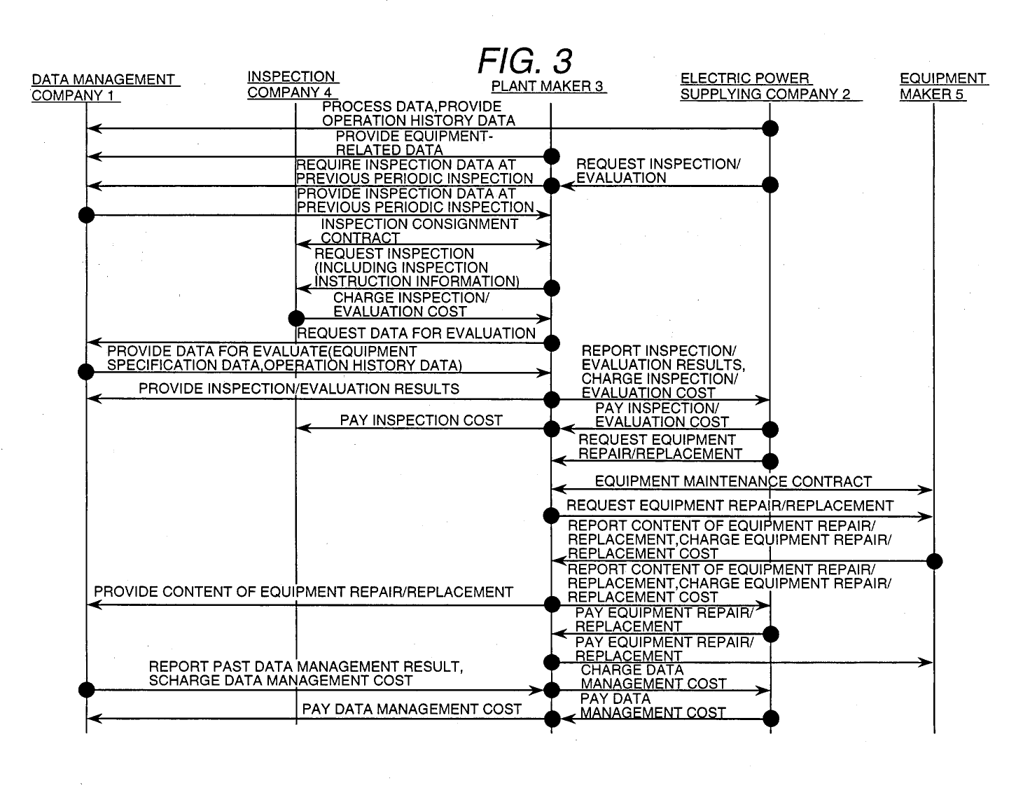

The first embodiment relates to an application of this invention to management business of inspection data of plant configuration equipment in a nuclear power plant (hereinafter simply referred to as a plant), and operation data of the plant. FIG. 1 shows a schematic system configuration view relating to the management business according to the first embodiment. FIG. 2 shows a contract form explanatory view relating to the management business according to the first embodiment. FIG. 3 shows an outline business flow view relating to the management business according to the first embodiment.

As shown in FIG. 1, organizations concerning this management business are a data management company 1, an electric power company 2, and a plant maker 3. an inspection company 4, an equipment maker 5, etc. The plant maker has a local office located within the plant and a remote office located outside of the plant. Each of these organizations is connected each other through a network such as Internet, etc.

In this embodiment, as shown in FIG. 2,, the data management company 1 concludes a data management contract between the electric power company 2 and the plant maker 3. This data management contract may be a yearly contract, for example. This embodiment relates to an example in which the electric power company 2 who is the owner of the plant requests (entrusts) the inspection and evaluation (diagnosis) of the plant configuration equipment to the plant maker 3.

In this specification, the plant configuration equipment (hereinafter referred to as simply equipments) include a reactor pressure vessel (hereinafter referred to as RPV), an in-reactor structure and in-reactor equipment within the RPV, a fuel assembly, an out-of-reactor accessory equipment outside of the RPV, a pipe arrangement system equipment connected to the RPV, a turbine, a electric power generator, etc.

The in-reactor structure and in-reactor equipment includes a steam dryer, a steam separator, a shroud band, a jet pump, a control rod, a neutron flux monitor (hereinafter referred to as ICM), etc. The out-of-reactor accessory equipment includes a control rod driving mechanism (hereinafter referred to as CRD), a CRD housing, an ICM housing, etc. The pipe arrangement system equipment include a pipe arrangement and equipment for a main steam system, a pipe arrangement and equipment for a condensed water/supplied water system, a pipe arrangement and equipment for a reactor recirculation system, a pipe arrangement and equipment for a reactor purification system, etc.

Hereinafter, the management business according to the first embodiment is explained using FIG. 3. First of all, the data management company 1 obtains operation data such as process data of the plant, operation history data and the like from the electric power company 2 through the network 10, in accordance with a data management contract. This process data comprises an online monitored data which includes water quality data, radiation dose data, environment data, etc. This monitored date also includes a nuclear reactor output, an electric generator output, etc. The operation history data includes past process data such as water quality history data, radiation dose history data and the like. Further, this operation history data includes maintenance history data relating to part exchange, repair, repair details and the like, operation cycle data (data concerning the operation cycle of the plant), etc.

Also, the data management company acquires equipment relevance data such as equipment design data, inspection data, trouble and failure data, standard data, etc. from the plant maker 3 through the network 10, in accordance with a data management contract. The equipment design data includes data relating to drawings, design conditions, specifications, materials, etc. The specification data comprises the size, model, capacity, etc. of the equipment. The material data comprises material quality, component composition, etc. The equipment inspection data includes the date of inspection, the contents of inspection, the result of inspection, the result of evaluation, etc. The evaluation result is the result relating to the goodness of the equipment which includes the exchange date of a part (or equipment), the result of life estimation, etc. The equipment trouble and failure data includes the name of the equipment of which trouble was found, its position, the result of evaluation, the contents of measures, etc. The equipment standard data is the specification necessary to the equipment and the like.

These equipment management data (process data, operation history data and equipment-related data) are stored in a memory device (database) of within a server of the data management company 1 every plant which is owned by the electric power company 2.

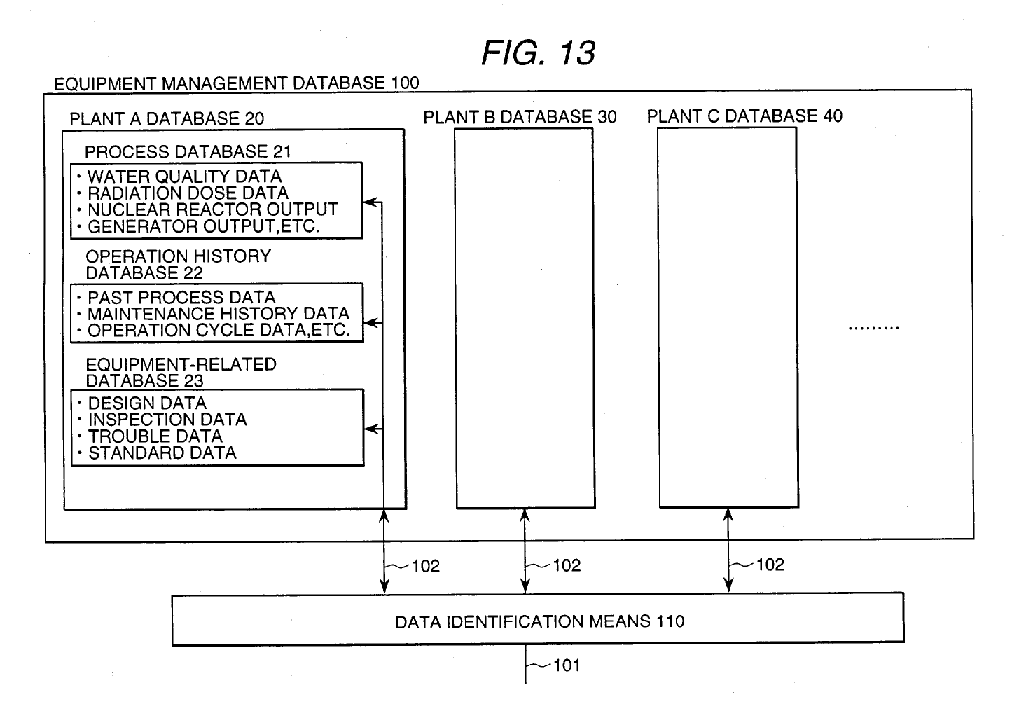

FIG. 13 shows an outlined block diagram of the equipment management database 100 and data identification means 110 which the server of the data management company has. The equipment management database 100 provides a plant A database 20, a plant B database 30 and a plant C database corresponding to plants A, B, and C, respectively, preserved by the electric power company 2. The plant A database 20 has a process database 21 in which said process data is stored, an operation history database 22 in which said operation history data is stored and an equipment-related database 23 in which said equipment-related data is stored.

The data identification means 110 identifies the association (affiliation) of each data received from the electric power company 2 and the plant maker 3 through a data line 101 coupled to the network 10, with a respective plant and respective data shown in FIG. 13. For this purpose, to the data sent from the electric power company 2 and the plant maker 3 to the data management company 1, attribute information may be annexed. As the attribute information, it is possible to use identifier for identifying the attribute, for example.

The data identification means 110 identifies the database in which the received data should be stored by analyzing this attribute information (or the received data, per se, and stores the received data to which the attribute information is affixed the database identified through the data line 102. In this way, the equipment management data is stored with the status associated to the corresponding equipment, each plant which the electric power company 2 owns. Especially, the inspection data and equipment trouble data included in the equipment management data are stored with the association to the corresponding inspection date and equipment every plant. Also, hierarchical structure of the operation cycle/inspection date/maintenance work date, for example, every plant may be formed, and the save may be carried out with the association of the equipment management data with the corresponding equipment every hierarchical stricture.

Further, although omitted in FIG. 13, the plant B database 30 and plant C database 40 also have the same database structure as the plant A database 20.

The above-mentioned description is the basic data registration in this business. Further, the process data of these basic data is always provided on-line from the electric power company 2 to the data management company 1, and stored as the latest data

The plant maker 3, in case where received equipment inspection request and/or valuation request (hereinafter referred to as simply inspection/valuation request) from the electric power company 2, requests inspection data at the previous periodic inspection to the data management company 1. The data management company 1, in response to this request, extracts the inspection data at the corresponding inspection date from among the equipment-related data, and provides said extracted inspection data at the previous periodic inspection to the plant maker 3. Such request and provision of these inspection data are carried out through the network 10. The inspection data provided from the data management company 1 is stored in the server of the plant maker 3.

Now, one example of the inspection data saved in the equipment-related database 23 is explained. FIG. 14 is a data management table showing an example of the inspection data. As shown in FIG. 14, the inspection data is saved with the state associated to (corresponded to) an inspection object equipment every plant and every inspection date. FIG. 14 shows one example of carried out to the five equipments (condenser, condenser pump, condenser filter, condenser pipe arrangement A, condenser pipe arrangement B) of a condenser system (system name) in the seventh periodic inspection (2001.7.1-7.7) of the plant A. This inspection data is an example in which data without affixed attribute information was stored.

In this case, contour inspection and exercise are carried out to first three equipments and the contour inspection and gash test are carried out to the remaining two equipments. An example in which the inspection result of four equipments other than the condenser filter show goodness and the inspection result of the condenser filter shows “pressure loss is high” (the pressure loss at the front and rear of the filter is high. To this inspection result of “pressure loss is high”, the valuation result of “filter change is needed” is judged, and “filter change” is saved as the maintenance history data.

In case where the inspection data at the previous periodic inspection concerning the plant A is requested from the plant maker 3 to the data management company 1, the data identification means 110 extracts the seventh periodic inspection data (FIG. 14) corresponding to the previous inspection from among the inspection data saved in the equipment relevance database 23 of the plant A database 20, and sends this inspection data to the plant maker 3.

The plant maker 3 displays the inspection data of FIG. 14 stored in the own server on a terminal display, and can provide, by selecting on the display an item necessitating detailed information, the validation on the display the detailed information concerning the selected item. The selection of the item may be performed, for example, by using a mouse for providing click selection on the display to the item which the selection is wished.

For example, in case where the equipment name was selected, the design data, standard data, etc. concerning that equipment are displayed. In case where the inspection content was selected, the inspection date, inspection trick, etc. are displayed. In case where the inspection result was selected, the detailed information of the inspection result is displayed. In case where the evaluation result was selected, the base running into the valuation result, etc. is displayed. The maintenance history data was selected, the maintenance date, maintenance detailed information, etc. displayed.

Next, the plant maker 3 makes out an inspection schedule on the basis of the inspection data which was obtained from the data management company 1, and requests the inspection to the inspection company 4. At this time, the plant maker 3 provides inspection instruction information concerning the inspection schedule, inspection specification and record specification to the inspection company 4. The inspection schedule defines completion time every inspection item. The inspection specification defines the detailed content of each inspection item, necessary personnel framing, etc. The record specification defines the detailed report content of each detection item.

The inspection company 4 performs the inspection of the equipment on the basis of the inspection instruction information, reports (provides) the inspection result to the plant maker 3, and charges an inspection cost. The provision of the inspection is effected through the network 10. The inspection result provided by the inspection company 4 is served in the server of the plant maker 3.

The plant maker 3 judges whether or not the inspection result provided by the inspection company 4 is sufficient (suitable). If this judgment result is insufficient (unsuitable), the plant maker 3 requests recheck to the inspection company 4 (not shown).

The plant maker 3 requests the data for evaluation (data necessary for the evaluation of the equipment) used for the evaluation of the equipment to the data management company 1, in consideration of the inspection result. In response to this request, the data management company 1 extracts the corresponding data for evaluation from among the equipment management data, and provides the extracted data for evaluation to the plant maker 3. The data for evaluation includes equipment specification data, current process data, operation history data, etc. These request and provision are effected through the network 10. The data for evaluation provided from the data management company 1 is stored in the server of the plant maker 3.

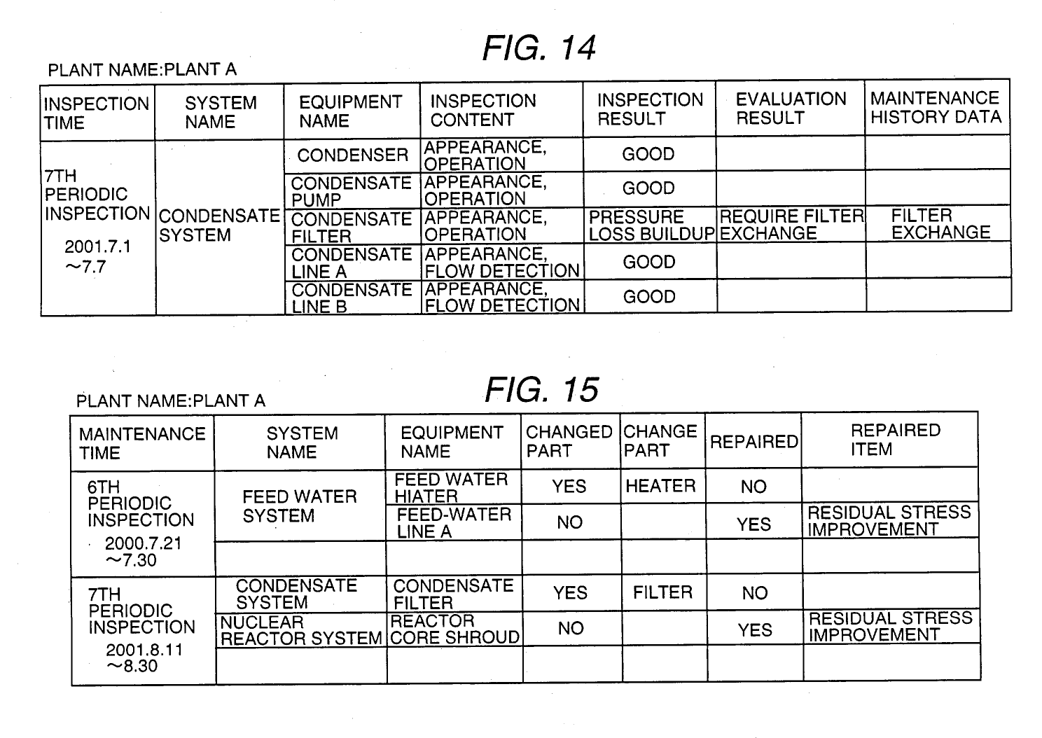

Now, one example of the maintenance history data stored in the operation history database 22 is explained. FIG. 15 is a data management table showing one example of the maintenance history data. As shown in FIG. 15, the maintenance history data is stored with the state associated (corresponded) to the maintenance object equipment every plant and every maintenance work date. FIG. 15 shows one example of the maintenance history data performed to a feed water heater and feed water pipe arrangement A of a feed water system (system name)in the sixth periodic inspection (2000.7.21-7.30) of the plant A, and the maintenance history data performed to the condensed water filter of a condenser system of a condenser system (system name) and the reactor core shroud of a nuclear reactor system in the seventh periodic inspection (2001.8.11-8.30) of the plant A. This maintenance history data is an example in which the data without the attribute information affixed thereto is stored.

In this case, in the sixth periodic inspection the heater of the feed water heater is exchanged and residual stress improving process is performed for the repair of the feed water pipe arrangement A. In the seventh periodic inspection, the filter portion of the condenser filter is exchanged, and residual stress improving process is performed for the repair of the reactor core shroud.

In case where the maintenance history data of the feed water system as the data for evaluation is requested from the plant maker 3 to the data management company 1, the data identification means 110 extracts the maintenance history data at the sixth periodic inspection in which the system name is the feed water system from among the maintenance history data (FIG. 15) of the plant A stored in the operation history database 22 of the plant A database 20, and sends this maintenance history data to the plant maker 3. Further, the data identification means 110 extracts the maintenance history data in which system name is the feed water system from among the maintenance history data of the plant B database 30 and plant C database 40, and this maintenance history data is also sent to the plant maker 3.

The plant maker 3 displays the maintenance history data stored in the own server on a terminal display, and can provide, by selecting on the display an item necessitating detailed information, the validation on the display the detailed information concerning the selected item. The selection of the item may be performed, for example, by using a mouse for providing click selection on the display to the item which the selection is wished.

For example, in case where the equipment name was selected, the design data, standard data, etc. concerning that equipment are displayed. In case where the replacement part was selected, the changed date, the name of the replaced part (portion), its specification, etc are displayed. In case where the repair content was selected, the repair date, repaired parts name (portion name), detailed repair information, etc. are displayed.

By this means, the plant maker 3, in evaluating the equipment of the plant A, for example, can evaluate the goodness of the overall equipment by considering also the maintenance history data of the corresponding equipment in the other plant.

Next, the plant maker 3 executes the evaluation (diagnosis) the equipment using the data for evaluation obtained from the data management company 1 and the inspection result obtained from the inspection company 4, reports (provides) the inspection result and/or evaluation result (hereinafter, simply referred to as inspection/evaluation results) to the electric power company 2, and charges a inspection cost and/or evaluation cost (hereinafter, simply referred as inspection/evaluation costs). As the evaluation result, there are “normality”, “measures are unnecessary although abnormality exists”, “measures, etc. are necessary because abnormality exists”, for example. This provision of the inspection/evaluation results are carried out through the network 10. The inspection/evaluation results provided by the plant maker 3 are stored in the server of the electric power company 2.

Also, the plant maker 3 provides the inspection/evaluation data also the data management company 1 through the network 10. This inspection/evaluation data is stored (additionally registered or updated) in the equipment-related database 23 of the relating plant of the data management company 1 as inspection data. In case where the evaluation result includes something wrong (in the case of abnormality), the evaluation result is stored in the equipment-related database 23 of the related plant of the data management company 1 also as wrong data.

The electric power company 2 judges whether or not the inspection/evaluation results which were provided by the plant maker 3 are sufficient (suitable). If this judgment result is insufficient (unsuitable), the electric power company 2 is requests re-inspection and/or re-evaluation 9 (hereinafter, simply referred to as re-inspection/re-evaluation) (not shown). In case where the judgment result is sufficient (suitable), the electric power company 2 judges the necessity of equipment measures as described later, on the basis of the inspection/evaluation results which were provided from the plant maker 3. The equipment measures include the repair, change of the equipment, etc.

Also, in case where the judgment results are sufficient, the electric power company 2 pays the inspection/evaluation costs to the plant maker 3 in response to the demand from the plant maker 3. This inspection/evaluation costs have predetermined according to conditions such as the contents of the inspection/evaluation, the existence of the re-inspection/re-evaluation or the like in the data management contract.

On the other hand, if the inspection result provided from the inspection company 4 is sufficient, the plant maker 3 pays the inspection cost to the inspection company 4 in response to the request from the inspection company 4. This inspection cost has predetermined depending on the conditions such as the inspection contents, the necessity of re-examination or the like. The payment conditions of the inspection cost is specified in the inspection consignment contract between the plant maker 3 and the inspection company 4.

If the electric power company 2 judged that there is necessity of the equipment measures, the electric power company 2 requests the repair and/or replacement of the equipment (hereinafter, simply referred to as repair/replacement) to the plant maker 3. The plant maker 3 requests the equipment repair/replacement to the equipment maker 5 in answer to this order. These requests are carried out through the network 10.

The equipment maker 5 carries out the equipment repair/replacement in response to the order from the plant maker 3. The equipment maker 5 reports provides) the repair/replacement content which was carried out to the plant maker 3 through the network 10. The repair/replacement content of the equipment which was provided by the equipment maker 5 is stored in the server of the plant maker 3. Also, the equipment maker 5 charges the cost (hereinafter, simply referred to as repair/replacement cost) for the equipment repair/replacement which was carried out, to the plant maker 3.

The plant maker 3 judges whether or not the replace/replacement content of the equipment which was reported by the equipment maker 5 satisfies the order content from the electric power company 2. In case where this judgment result is dissatisfactory, the plant maker 3 re-requests the equipment repair/replacement to the equipment maker 5 (not shown). The above-mentioned judgment result is satisfactory, the plant maker 3 reports (provides) the repair/replacement content of the equipment which was carried out to the electric power company 2, and charges the repair/replacement costs of the equipment. The report of this repair/replacement content of the equipment is conducted through the network 10. The repair/replacement content of the equipment provided by the plant maker 3 is stored in the server of the electric power company 2.

Also, the plant maker 3 provides the repair/replacement content of the equipment also to data management company 1 through the network 10. This repair/replacement content of the equipment is stored (additionally registered or updated) in the operation history database 22 of the corresponding plant of data management company 1 as the maintenance history data (operation history data of the equipment.

The electric power company 2 judges whether the repair/replacement content of the equipment which was provided by the plant maker 3 is sufficient (suitable). This judgment result showed insufficiency (inadequacy), the electric power company 2 requests again the equipment repair/replacement to the plant maker 3 (not shown). The judgment result showed sufficiency (pertinence), the electric power company 2 pays the repair/replacement cost of the equipment to the plant maker 3, in answer to the charge from the plant maker 3. This repair/replacement cost of the equipment has been predetermined according to the conditions such as the equipment repair/replacement, the presence of the re-order and the like, based on the data administration contract.

On the other hand, the plant maker 3 pays the repair/replacement cost to the equipment maker 5 in response to the charge from the equipment maker 5. This repair/replacement cost of the equipment has been predetermined in accordance with the conditions such as the repair/replacement content, the presence of the re-order and the like. The payment condition of the equipment repair/replacement is defined in an equipment maintenance contract between the plant maker 3 and the equipment maker 5.

The data management company 1 reports data administration performance to the plant maker 3 on the basis of the data administration contract, and charges the data administration cost. This data administration performance includes the repair/replacement result which was provided from the plant maker 3, administration work such as the additional registration or update, etc. of data regarding the repair/replacement content of the equipment and administration work such as the additional registration of process data which was provided from the electric power company, etc. These administration works are carried out by the data administration part (not shown) of the server of the data management company 1. This data administration part transmits the data administration performance to the plant maker 3 through the network 10, and the transmitted data administration performance is stored in the server of thee plant maker 3.

The plant maker 3 charges the burden share of the data administration cost to the power company 2 on the basis of the data administration contract. The electric power company 2 pays the data administration cost to the plant maker 3 in response to this charge. The plant maker 3 pays the data administration cost to the data management company 1 in response to the charge from the data management company 1. The data administration contract may be concluded so that the data management company 1 can charge the burden shares of the data administration cost of the electric power company 2 and the plant maker 3 to these respective companies.

As described above, the data management company performs the data unitary administration of the operation data and equipment-related data (including the inspection data) in a plant. The electric power company 2 and the plant maker 3 can obtain the inspection data operation data from the data management company 1 if necessary.

In this embodiment, the electric power company 2 and the plant maker 3 do not manage flood of data relating to the equipment administration by there selves, but can easily obtain necessary data from the data management company 1 if necessary, and therefore it is possible decrease the cost which is needed for the data administration. Also, in case where the goodness of the equipment is evaluated, it is possible to use also the equipment management data in another nuclear power plant held by the electric power company 2, and therefore it is possible to carry out easily and efficiently the composite (that is, highly reliable) equipment goodness evaluation. By this, it is possible to plan (prepare) efficiently the inspection plan, operation plan and maintenance plan of a plant

In order to utilize the equipment management data in another nuclear power plant for the goodness evaluation, as illustrated in FIG. 13˜FIG. 15, the equipment management database 100 which the equipment administration company has preserves the inspection data in the state having association with (correspondence to) the inspection date, inspection object (system name, equipment name), inspection result, evaluation result, etc. every plant. Also, the equipment management database 100 preserves the maintenance history data in the state having association with (correspondence to) the inspection date, inspection object (system name, equipment name), maintenance content (exchanged part, repair detail, etc.), etc. every point.

Further, the evaluation contents which the plant maker 3 performs include, in addition to the above-mentioned example, corrosion environment evaluation, crack growth evaluation, stress evaluation, work environment forecast evaluation, exposure ray amount forecast evaluation, waist generation amount forecast evaluation, etc. These evaluation results can contribute to the planning of the economic maintenance of the plant, and this can apply abnormality preecho diagnosis, damage life diagnosis, support to trouble, comprehensive diagnosis for plant performance, etc.

The data identification means 110 which the data management company 1 has extracts the inspection, maintenance history data, design data, disadvantage data, etc. relating to the equipment corresponding to the objective equipment to the goodness evaluation, out of the equipment data relating to another nuclear power plant, in response to the request from the plant maker 3, and transmits the same to the plant maker 3. The plant maker 3 carries out the comprehensive goodness evaluation of the equipment in consideration of also the equipment management data in the other nuclear power plant obtained in this way.

Also, the data identification means 110 can retrieve relevant data every plant, every system, every equipment, every inspection date, every maintenance date, every inspection result, every evaluation result and every maintenance content in association with the equipment management data stored in the equipment management database 100, if necessary.

Also, in this embodiment, the plant maker 3 may carry out the inspection work by itself. In this case, the inspection order, inspection report, etc. between the plant maker 3 and the inspection company 4 are omitted. Further, the plant maker 3 may carry out the equipment repair/replacement by itself. In this case, the repair/replacement order of the equipment, the repair/replacement content report of the equipment, etc. between the plant maker 3 and the equipment maker 5 are omitted.

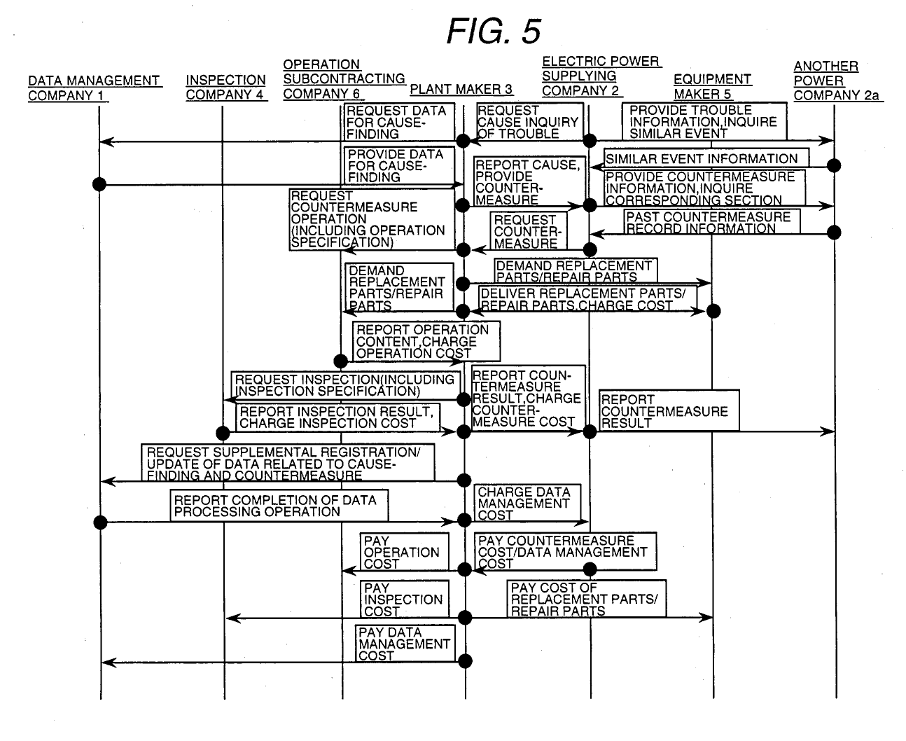

Next, in case where the disadvantage of the equipment was reported as the inspection/evaluation results of the first embodiment, one example of subsequent processes are explains using FIG. 5. FIG. 5 is an outline business flow diagram showing one example in which the electric power company 2 requests the cause investigation and measures of the disadvantage to the plant maker 3 in the first embodiment. Further, also in this case the send and receive of data (information) between the interested parties are effected through the network 10, and the data which each interested party received is stored in the server which he owns.

As shown in FIG. 5, in case where the disadvantage of the equipment is reported as the inspection/evaluation results in FIG. 3 and the electric power company 2 judged the cause investigation of the disadvantage is needed, the electric power company 2 requests the cause investigation of the disadvantage to the plant maker 3. For example, as one example of the disadvantage of the equipment, the abnormality of the equipment, for example, was found in a periodic inspection, as the cause of this the case in which water leakage arose during the operation of the plant, for example, can be thought.

The plant maker 3 requests data necessary to the cause investigation and measure decision (hereinafter, simply referred to as cause investigation data) to the data management company, in response to this cause investigation order. In answer to this request, the data management company 1 extracts corresponding cause investigation from among the equipment management data, and provides the extracted cause investigation data to the plant maker 3. The cause investigation data includes inspection data, maintenance history data, design data, disadvantage data, etc.

The plant maker 3 investigates the cause of the disadvantage on the basis of the cause investigation data which was obtained from data management company 1, and determines measures for removing this cause. In order to perform this cause investigation and measure decision, the data which the plant maker 3 acquired independently may be used. Next, the plant maker 3 reports the case of the disadvantage to the electric power company 2, and advises the measures.

On the other hand, the electric power company 2 supplies the disadvantage information (information relating to the disadvantage) to another electric power company 2a, performs the referral of a similar event (similar case), and obtains the similar event information (information relating to the similar event) from the other electric power company 2a. The similar event information includes the presence of the similar event, measures, actual condition, etc. Furthermore, the electric power company 2 supplies the measure information (information relating to the measures) which was advised from the plant maker 3 to the other electric power company 2a, performs the referral of the corresponding part, and acquires the measure performance information from the other electric power company 2a. The measure performance information includes the presence of the similar measure effectuation in the corresponding part, actual condition, etc.

Next, the electric power company 2 investigates the measure information advised from the plant maker 3, the similar event information which was obtained from the other electric power company 2a, the measure effectuation information, etc., determines measure contents, and requests the measures of the disadvantage to the plant maker 3. The plant maker 3 prepares a work specification sheet (work point sheet) corresponding to the measure content ordered from the electric power company 2, and requests the measure work to a work subcontract company 6.

In case where a replacement good and/repair good (hereinafter, simply referred to as replacement good/repair good) became necessary in the measure which was ordered by the electric power company 2, the plant maker 3 requests the corresponding replacement good/repair good to the equipment maker 5. The equipment maker 5 delivers the replacement good/repair good to the plant maker 3, and charges the expense. The plant maker 3 supplies the cost of the replacement good/repair good which was obtained by from the equipment maker 5 to the work subcontract company 6.

The work subcontract company 6 performs the measure work in accordance with the work specification sheet from the plant maker 3, reports the measure work content to the plant maker 3 after the work has completed (finished), and charges the work cost. Further, a department in the plant maker 3 may work in place of the work subcontract company 6.

Next, the plant maker 3 prepares the inspection specification sheet (inspection point sheet) for checking whether or not the measure work content which the work subcontract company 6 carried out satisfies the request of the work specification sheet, and requests the inspection in question to the inspection company 4. The inspection company 4 carries out the inspection in accordance with this inspection specification, reports the inspection result to the plant maker 3 after the inspection has completed (finished).

Next, the plant maker 3 confirms whether or not the measure work content which the work subcontract company 6 carried out passes through the inspection carried out by the inspection company 4. In case where the measure work content has not been passed through the inspection, the plant maker 3 re-requests the measure work to the work subcontract company 6 (not shown). In case where the measure work content has passed through the inspection, the plant maker 3 reports the measure result (includes the measure work content, inspection result) to the electric power company 2, and charges the measure cost.

The electric power company 2 judges whether or not the measure result provided form the plant maker 3 is satisfied by the measure content which was ordered. In case where the judgment result has not been satisfied, the electric power company 2 re-requests the measures to the plant maker 3 (not shown). In case where the judgment has been satisfied, the electric power company 2 reports the measure result provided from the plant maker 3, to the other electric power company 2a.

Also, the plant maker 3 provides data relating to the above-mentioned cause investigation and measures to the data management company 1, and requests the additional registration and or update of the date in question. The data management company 1 performs the additional registration or update of this data as the maintenance history data, disadvantage data, reports the completion of these data process works to the plant maker 3, and charges the data administration cost. The plant maker 3 charges the electric power company burden share of the data administration cost on the basis of the data administration contract.

The electric power company 2 pays the measure cost and data administration cost to the plant maker 3 in response to the demand from the plant maker 3. The plant maker 3 pays the data administration cost to the data management company, the inspiration cost to the inspection company 4, the working cost to the work subcontract company 6 and the expense for the replacement good/repair good to the equipment maker 5, respectively.

As mentioned above, also in the case where the equipment disadvantage is detected, the electric power company 2 can make measures effectively by using the equipment data which is administrated integrally in the data management company 1. Furthermore, the electric power company 2 can take the measures more effectively for the disadvantage by using the similar event information, the measure performance information, etc. in the other electric power company 2a.

Further, in the above-mentioned example, the case in which the electric power company 2 acquires the similar event of the disadvantage and measure performance information from the other electric power company 2a was explained, but the data management company 1 may administrate unifiedly the equipment management data of the other electric power company 2a including these information. In this case, the electric power company 2 acquires the similar event information of the disadvantage and the measure performance information in the plant stored by the other electric power company 2a, from the data management company 1, and can take the measures effectively for the disadvantage.

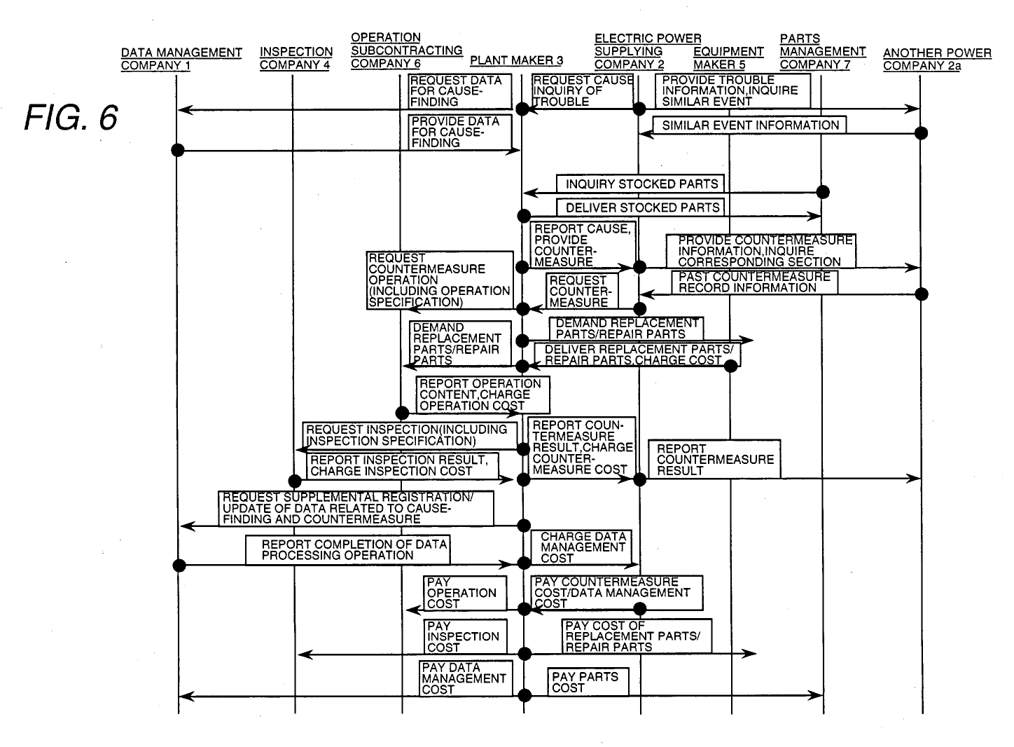

Next, in the case where the disadvantage of the equipment was reported as the inspection/evaluation results of the first embodiment, another example after this is explained by using FIG. 6. FIG. 6 shows an outline business flow view illustrating another case in which the electric power company 2 requests the cause investigation of the disadvantage and the measures to the plant maker 3 in the first embodiment.

In FIG. 6, a parts management company 7 is added to the interested party of FIG. 5. The parts management company 7 stocks parts used in the plant, and the parts stocked in the parts management company 7 for a plurality of plants are used commonly. This example may need the reappearance test of the disadvantage using the part in which the disadvantage occurred in order to investigate the cause of the disadvantage.

In this case, the plant maker 3 inquires whether the same part as one in which the disadvantage occurred is stocked to the parts management company 7 (referral of the stock part). If the required part is stocked, the parts management company 7 delivers the part in question to the plant maker 3 (delivery of the stocked part) to the plant maker 3, and charges the parts cost. The plant maker 3 makes the reappearance test of the disadvantage by using the part obtained from the parts management company 7.

The plant maker 3 investigates the cause of the disadvantage on the basis of the result of this reproduction test and the cause investigation data obtained from data management company 1. Also, the plant maker 3 pays the parts cost to the parts management company 7 after the measure cost and data administration cost have been received. Since other processes are the same as those in FIG. 5, the explanation therefor is omitted here.

In this way, by interposing the parts management company 7, also in case where the reproduction test is needed, the part can be procured rapidly and therefore it is possible to intend certainly the cause investigation.

(Second Embodiment)

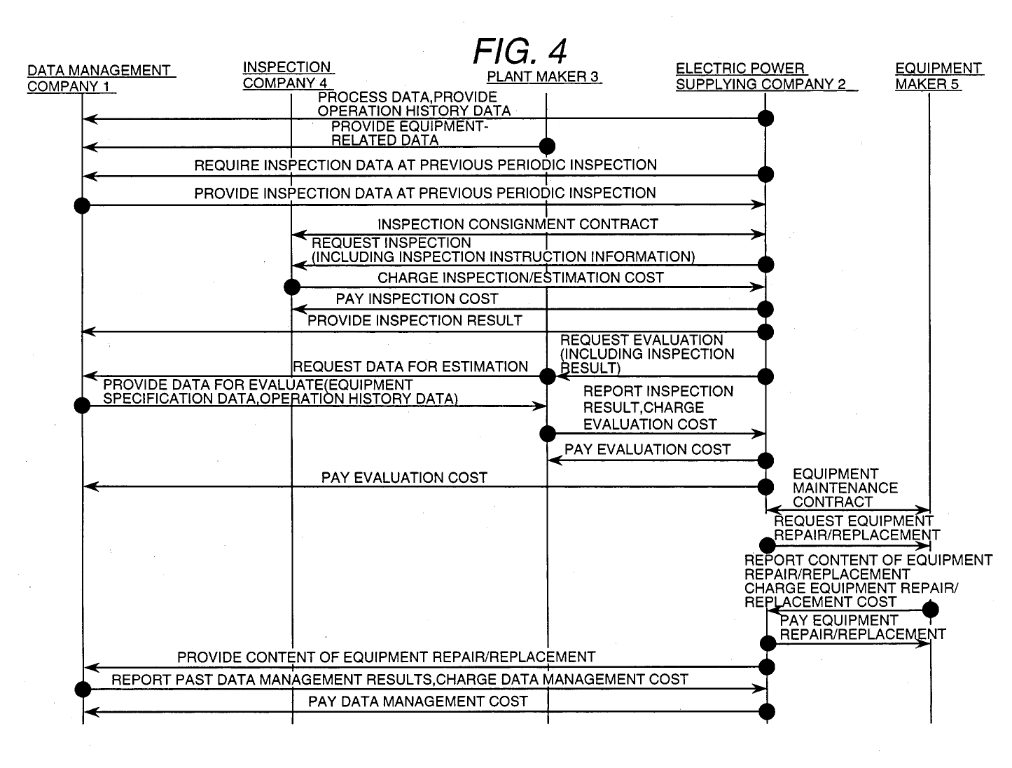

Next, a second embodiment in which the present invention is applied to an management business for the inspection data of equipment in a plant and operation data in the plant is explained by using FIG. 4. FIG. 4 is an outline business flow view relating to the management business according to the second embodiment. In this embodiment, the system construction shown in FIG. 1 and the contract mode shown in FIG. 2 are the same as those in FIG. 1.

The points in which this embodiment differs from the first embodiment is that the electric power company 2 requests the inspection to the inspection company 4 directly, that the electric power company 2 requests the equipment repair/replacement to the equipment maker 5 directly, and that the electric power company 2 pays the data administration cost to the data management company 1 directly. That is, the electric power company 2 order only the evaluation (diagnosis) of the equipment to the plant maker 3.

As shown in FIG. 4, the provision of the posses data and operation history data from the electric power company 2 to the data management company 1 and provision of the equipment management data from the plant maker 3 to the data management company 1 are made in the same manner as in the case in the first embodiment. That is the basic data registration in this business is the same as one in the first embodiment.

The electric power company 2 requests inspection data at the previous periodic inspection to the data management company 1 before requesting the inspection of equipment. The data management company 1, in response to this request, extracts the inspection data at the corresponding inspection date from among the equipment-related data, and provides said extracted inspection data at the previous periodic inspection to the power company 2. Such request and provision of these inspection data are carried out through the network 10. The inspection data provided from the data management company 1 is stored in the server of the power company 2.

Next, the power company 2 makes out an inspection schedule on the basis of the inspection data obtained from the data management company 1, and requests the inspection to the inspection company 4. At this time, the power company 2 provides inspection instruction information to the inspection company 4. The inspection company 4 carries out the inspection of equipment based on these inspection instruction information, and reports (provides) the inspection result and charges the inspection cost to the power company 2. The provision of the inspection result is effected through the network 10. The inspection result provided by the inspection company 4 is served in the server of the power company 2.

The power company 2 judges whether or not the inspection result provided from the inspection company 4 is sufficient (suitable). If this judgment result is insufficient (unsuitable), the power company 2 requests recheck to the inspection company 4 (not shown). If the inspection result provided from the inspection company 4 is sufficient, the power company 2 pays the inspection cost to the inspection company 4 in response to the request from the inspection company 4. This inspection cost has predetermined depending on the conditions such as the inspection contents, the necessity of re-examination or the like. The payment conditions of the inspection cost is specified in the inspection consignment contract between the power company 2 and the inspection company 4.

Also, If the judgment result is sufficient, the power company 2 provides the inspection result to the data management company 1 through the network 10. This inspection result is stored (additionally registered or updated) in the equipment-related database 23 of the data management company 1 as inspection data.

Next, the power company 2 requests the evaluation (diagnosis) of the equipment to the plant maker 3. At this time, the power company 2 provides the inspection result obtained from the inspection company 4. The provision of the inspection result and the request of the evaluation is effected through the network 10.

The plant maker 3 requests the data for evaluation used for the evaluation of the equipment to the data management company 1, in consideration of the inspection result. In response to this request, the data management company 1 extracts the corresponding data for evaluation from among the equipment management data, and provides the extracted data for evaluation to the plant maker 3. The data for evaluation includes equipment specification data, up-to-date process data, operation history data, etc. These request and provision are effected through the network 10. The data for evaluation provided from the data management company 1 is stored in the server of the plant maker 3.

The plant maker 3 executes the evaluation (diagnosis) of the equipment using the data for evaluation obtained from the data management company 1 and the inspection result obtained from the inspection company 4. The plant maker 3 reports (provides) the evaluation result to the electric power company 2, and charges the evaluation cost. The evaluation result provided from the plant maker 3 are stored in the server of the electric power company 2.

The electric power company 2 judges whether or not the evaluation result provided by the plant maker 3 is sufficient (suitable). If this judgment result is insufficient (unsuitable), the electric power company 2 requests re-evaluation (not shown). If the judgment result is sufficient (suitable), the electric power company 2 judges the necessity of equipment measures (repair/replacement) on the basis of the evaluation result provided from the plant maker 3.

Also, in case where the judgment results are sufficient, the electric power company 2 pays the evaluation cost to the plant maker 3 in response to the demand from the plant maker 3, and provides the evaluation result to the data management company 1 through network 10. This evaluation cost has predetermined according to conditions such as the contents of the evaluation, the existence of the re-evaluation or the like in the data management contract. The evaluation result provided from the power company 2 is stored (additionally registered or updated) in the equipment-related database 23 of the data management company 1. If the evaluation result includes the trouble of equipment, the evaluation result is stored in the equipment-related database 23 of the data management company 1 also as trouble data.

If the electric power company 2 judged that there is necessity of the equipment measures, the electric power company 2 requests the equipment repair/replacement to the equipment maker 5 through the network 10. The equipment maker 5 reports (provides) the contents of equipment repair/replacement effected through the network 10 to the power company 2, and charges the repair/replacement costs according to the contents of the repair/replacement. The contents of the repair/replacement provided from the equipment maker 5 is stored in the server of the power company 2.

The electric power company 2 judges whether or not the repair/replacement content of the equipment provided from the equipment maker 5 is sufficient (suitable). If this judgment result shows insufficiency (inadequacy), the electric power company 2 requests again the equipment repair/replacement to the equipment maker 5 (not shown). If the judgment result shows sufficiency, the electric power company 2 pays the repair/replacement cost of the equipment to the equipment maker 5, in answer to the charge from the equipment maker 5. This repair/replacement cost of the equipment has been predetermined according to the conditions such as the content of the equipment repair/replacement, the presence of the re-order and the like. The payment condition of the equipment repair/replacement is defined in an equipment maintenance contract between the power company 2 and the equipment maker 5.

Further, in case where the judgment result is sufficient, the power company 2 provides the repair/replacement content of the equipment also to data management company 1 through the network 10. This repair/replacement content of the equipment is stored (additionally registered or updated) in the operation history database 22 of the data management company 1 as the maintenance history data (operation history data) of the equipment.

The data management company 1 reports data administration performance to the power company 2 on the basis of the data administration contract, and charges the data administration cost. This data administration performance includes administration work such as the additional registration or update, etc. of data regarding the repair/replacement content of the equipment, the inspection/evaluation results and the process data provided from the electric power company. This report of the data administration performance is effected through the network 10, and the data administration performance provided from the data management company 1 is stored in the server of thee plant maker 3. The electric power company 2 pays the data administration cost to the data management company 1 in response to the charge from the data management company 1.

This embodiment also has substantially the same effects as the first embodiment. In this embodiment, the power company 2 may perform the inspection instead of the inspection company 4, and do repair/replacement of equipment instead of the equipment maker 5.

(Third Embodiment)

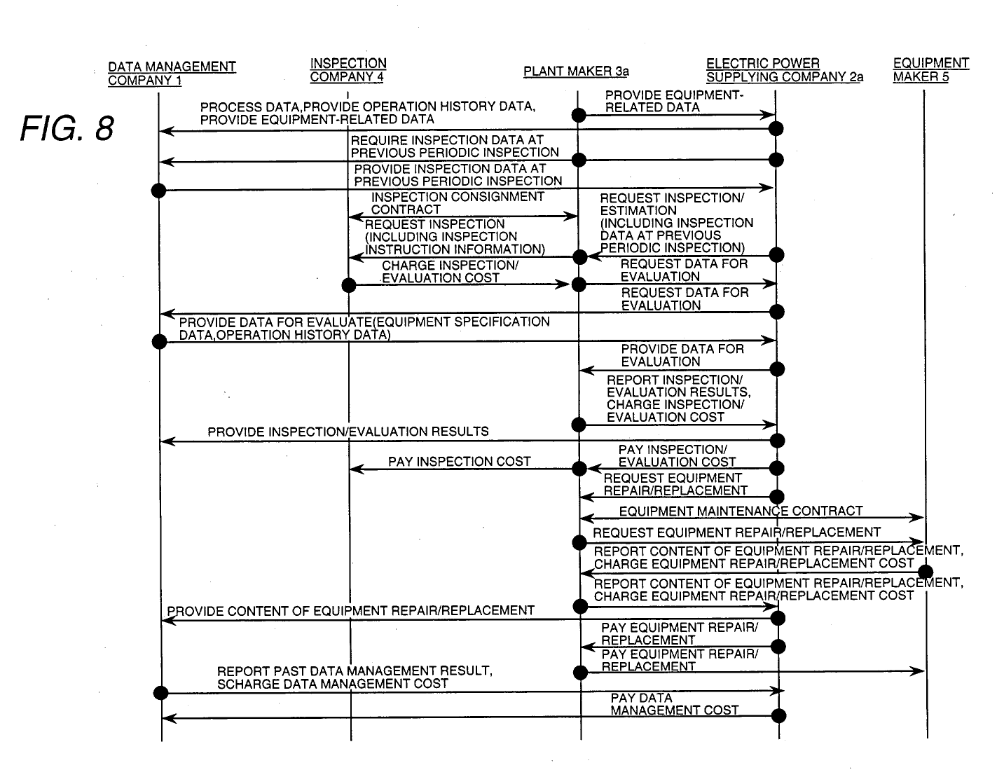

Next, a third embodiment in which the present invention is applied to an management business for the inspection data of equipment in a plant and operation data in the plant is explained by using FIG. 7 and FIG. 8. FIG. 7 is an illustration showing the contract mode relating to the management business according to the third embodiment. FIG. 8 is an outline business flow view relating to the management business according to the third embodiment.

In this embodiment, the data management company 1 concludes a data management contract with each of the power companies 2a and 2b as shown in FIG. 7. The electric power companies 2a and 2b conclude consignment contracts on inspection/evaluation with the plant makers 3a and 3b, respectively. These contracts are yearly contracts, for example. This embodiment shows an example in which the power company having a plant requests (consigns) the inspection/evaluation on equipment to the plant maker.

The system configuration of the management business according to the present embodiment is the same as that of the first embodiment shown in FIG. 1. Further, also in this embodiment, the send and receive of data (information) between parties concerned is performed through the network 10 as the first embodiment, and the data received by each party concerned is stored in his/her server.

The feature of this embodiment resides in that when the send/receive of data between the data management company 1 and the plant maker is performed, this send/receive is performed through the electric power company. The management business according to the third embodiment is explained hereinafter with reference to FIG. 8. Although FIG. 8 shows the business flow between the power company 2a and plant maker 3a for the sake of simplicity, the business flow between the power company 2b and plant maker 3b is substantially the same as one of FIG. 8. Even if the number of the power company and plant maker increases further, the business flow does not change.

Firstly, the plant maker 3a provides the equipment-related data to the power company 2a based on the consignment contract for the inspection and evaluation. The data management company 1 acquires the process data, the operation history data, and the equipment-related data in the plant from the power company 2a based on the data management contract. These equipment management data (process data, operation history data, and equipment-related data) are stored in the equipment management database 100 of the server of the data management company. The registration of the base data in this business has completed. Further, the process data among these base data is always provided from the power company 2a to the data management company 1, and is stored as the latest data.

The electric power company 2a requests the inspection data at the previous periodic inspection to the data management company 1 before requesting the inspection/evaluation of equipment to the plant maker 3a. The data management company 1, in response to this request, extracts the inspection data at the corresponding inspection date from among the equipment-related data, and provides said extracted inspection data at the previous periodic inspection to the power company 2a. The power company 2a provides the inspection data at the previous periodic inspection to the plant maker 3a, and requests the inspection/evaluation of equipment.

The plant maker 3a makes out an inspection schedule on the basis of the inspection data obtained from the power company 2a, and requests the inspection to the inspection company 4. At this time, the plant maker 3a provides inspection instruction information concerning the inspection specification and the record specification to the inspection company 4. The inspection company 4 carries out the inspection of equipment based on these inspection instruction information, reports (provides) the inspection result and charges the inspection cost to the plant maker 3a. The plant maker 3a judges whether or not the inspection result provided from the inspection company 4 is sufficient (suitable). If this judgment result is insufficient (unsuitable), the plant maker 3a requests recheck to the inspection company 4 (not shown).

The plant maker 3 requests the data for evaluation used for the evaluation of the equipment to the data management company 1, in consideration of the inspection result. In response to the request from the plant maker 3a, the electric power company 2a requests the data for evaluation to the data management company 1. In response to the request from the electric power company 2a, the data management company 1 extracts the corresponding data for evaluation from among the equipment management data, and provides the extracted data for evaluation to the power company 2a. The power company 2a provides the data for evaluation provided from the data management company 1 to the plant maker 3a.

The plant maker 3a executes the evaluation (diagnosis) of the equipment using the data for evaluation obtained from the power company 2a and the inspection result obtained from the inspection company 4. The plant maker 3 reports (provides) the inspection/evaluation results to the electric power company 2, and charges the inspection/evaluation costs. The electric power company 2a judges whether or not the inspection/evaluation results provided by the plant maker 3 are sufficient (suitable). If this judgment result is insufficient (unsuitable), the electric power company 2a requests re-inspection/re-evaluation (not shown).

If the judgment result is sufficient (suitable), the electric power company 2a judges the necessity of equipment measures (repair/replacement of equipment) on the basis of the inspection/evaluation results provided from the plant maker 3a. Also, If the judgment results are sufficient, the electric power company 2a pays the inspection/evaluation costs to the plant maker 3a in response to the demand from the plant maker 3a. This inspection/evaluation costs have predetermined according to conditions such as the contents of the inspection/evaluation, the existence of the re-inspection/re-evaluation or the like in the consignment contract of the inspection/evaluation.

Further, the power company 2a provides the inspection/evaluation results also to the data management company 1. The inspection/evaluation results are stored (additionally registered or updated) as the inspection data in the equipment-related database 23 of the data management company 1. If the evaluation result includes the trouble of equipment (the state of abnormality), the evaluation result is stored also as trouble data in the equipment-related database 23 of the data management company 1.

On the other hand, the inspection result provided the inspection company 4 is sufficient, the plant maker 3a pays the inspection cost to the inspection company 4 in response to the demand from the inspection company 4. The inspection cost has predetermined according to conditions such as the content of the inspection, the existence of the re-inspection or the like. The payment condition of inspection cost is defined in the inspection consignment contract between the plant maker 3a and the inspection company 4.

Next, when the electric power company 2a judged that there is necessity of the equipment measures, the electric power company 2a requests the equipment repair/replacement to the equipment maker 5. The plant maker 3a requests the equipment repair/replacement to the equipment maker 5. The equipment maker 5 executes the equipment repair/replacement according to the request from the plant maker 3a, and reports (provides) the contents of the equipment repair/replacement executed to the plant maker 3a. Further, the equipment maker 5 charges the repair/replacement costs for the equipment to the plant maker 3a.

The plant maker 3a judges whether or not the content of the equipment repair/replacement reported from the equipment maker 5 is sufficient (suitable) for the content of the request from the power company 2a. If this judgment result shows insufficiency (inadequacy), the plant maker 3a requests again the equipment repair/replacement to the equipment maker 5 (not shown). If the judgment result shows sufficiency, the plant maker 3a reports (provides) the executed equipment repair/replacement to the power company 2a, and charges the repair/replacement costs of the equipment.

The electric power company 2a judges whether or not the content of the equipment repair/replacement provided from the plant maker 3a is sufficient (suitable). If this judgment result shows insufficiency (inadequacy), the electric power company 2a requests again the equipment repair/replacement to the plant maker 3a (not shown). If the judgment result shows sufficiency, the electric power company 2a pays the repair/replacement costs of the equipment to the plant maker 3a, in answer to the charge from the plant maker 3a. This repair/replacement costs of the equipment have been predetermined according to the conditions such as the content of the equipment repair/replacement, the presence of the re-request and the like in the consignment contract of the inspection/evaluation.

The power company 2a provides the content of the equipment repair/replacement also to the data management company 1. This content of the equipment repair/replacement is stored (additionally registered or updated) in the operation history database 22 of the data management company 1 as the maintenance history data (operation history data) of the equipment.

The plant maker 3a pays the repair/replacement costs of the equipment to the equipment maker 5, in answer to the charge from the equipment maker 5. This repair/replacement costs of the equipment have been predetermined according to the conditions such as the content of the equipment repair/replacement, the presence of the re-request and the like. The payment condition of the equipment repair/replacement is defined in an equipment maintenance contract between the plant maker 3a and the equipment maker 5.

The data management company 1 reports the data administration performance to the power company 2a on the basis of the data administration contract, and charges the data administration cost. This data administration performance includes administration work such as the additional registration or update, etc. of data regarding the content of the equipment repair/replacement, the inspection/evaluation results provided from the electric power company 2a. The electric power company 2a pays the data administration costs to the data management company 1 in response to the charge from the data management company 1.

This embodiment also has substantially the same effects as the first embodiment. In this embodiment, the plant maker 3a may perform the inspection instead of the inspection company 4, and do the repair/replacement of equipment instead of the equipment maker 5.

(Fourth Embodiment)

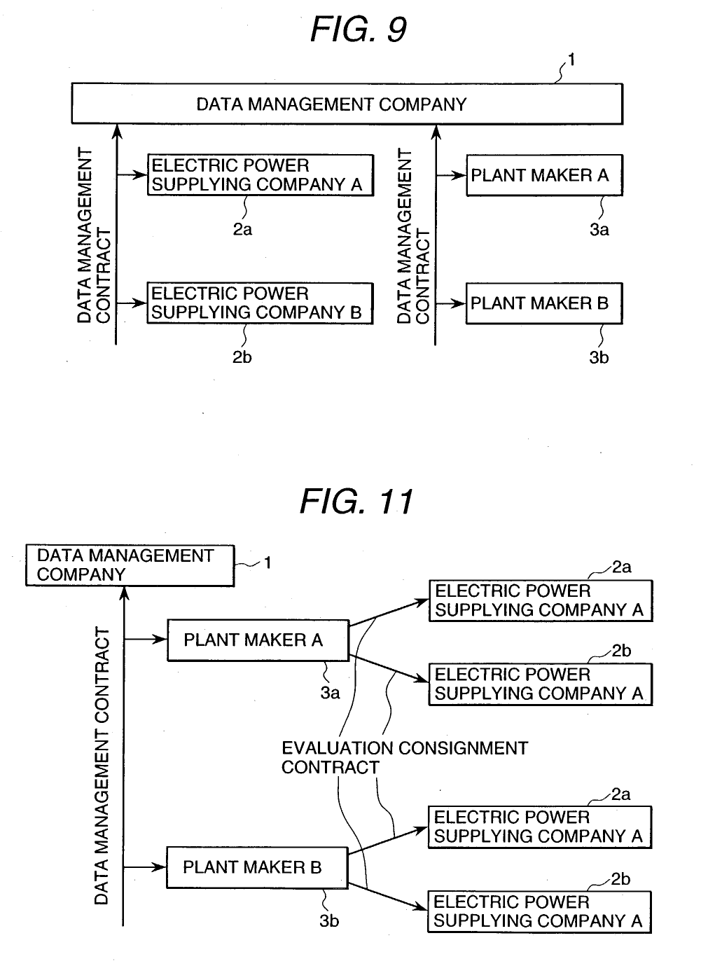

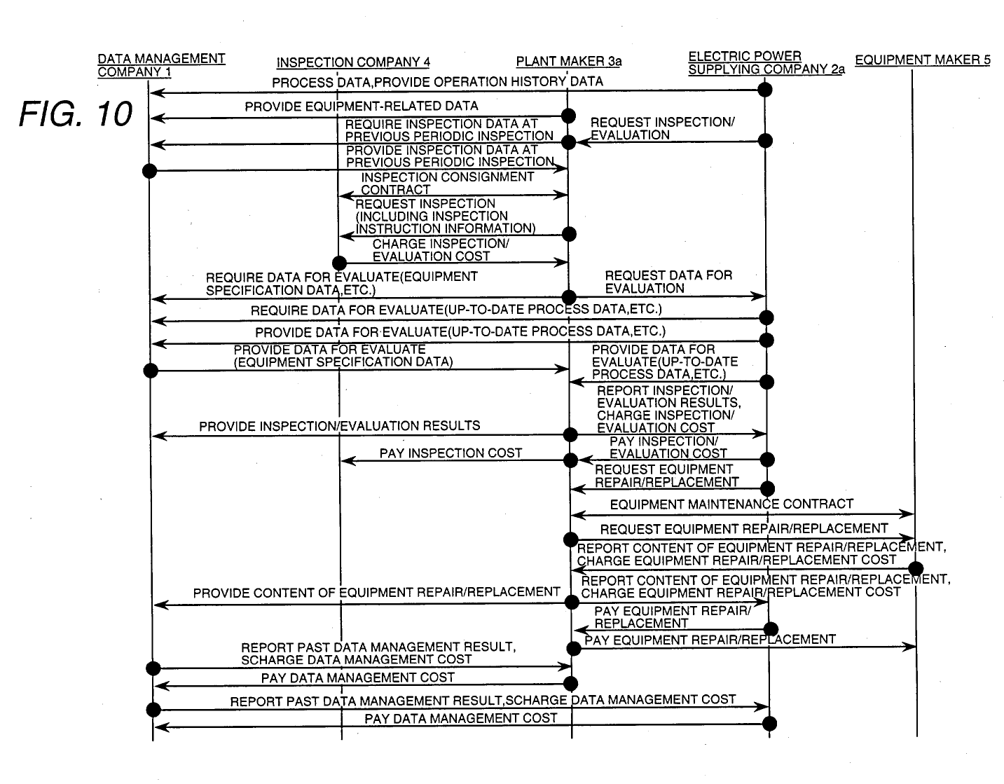

Next, a fourth embodiment in which the present invention is applied to an management business for the inspection data of equipment in a plant and operation data in the plant is explained by using FIG. 9 and FIG. 10. FIG. 9 is an illustration showing the contract mode relating to the management business according to the fourth embodiment. FIG. 10 is an outline business flow view relating to the management business according to the fourth embodiment.

In this embodiment, the data management company 1 concludes a data management contract with each of the power companies 2a, 2b and each of the plant maker 3a, 3b as shown in FIG. 9. These contracts are yearly contracts, for example. This embodiment shows an example in which the power company having a plant requests (consigns) the inspection/evaluation on equipment to the plant maker.

The system configuration of the management business according to the present embodiment is the same as that of the first embodiment shown in FIG. 1. Further, also in this embodiment, the send and receive of data (information) between parties concerned is performed through the network 10 as the first embodiment, and the data received by each party concerned is stored in his/her server.

The features of the present embodiment resides in that the data of which the administration responsibility belongs to the power company is sent/received between the data management company 1 and the power company, and the data of which the administration responsibility belongs to the plant maker is sent/received between the data management company 1 and the plant maker. Since, as shown in FIG. 10, the registration of the base data, the order of the inspection/evaluation from the power company to plant maker, the provision of the inspection data at the previous periodic inspection from the data management company to the plant maker, the order of the inspection from the plant maker to the inspection company, and the report of the inspection result from the inspection company to the plant maker, etc. are the same as those of the first embodiment shown in FIG. 3, the explanation is omitted here.

The business flow after the evaluation by the plant maker in the fourth embodiment is explained hereinafter with reference to FIG. 10. Although FIG. 10 shows the business flow between the power company 2a and plant maker 3a for the sake of simplicity, the business flow between the power company 2b and plant maker 3b is substantially the same. Even if the number of the power company and plant maker increases further, the business flow does not change.

The plant maker 3a requests the data for evaluation used for the evaluation of the equipment to the data management company 1 and the power company 2a, in consideration of the inspection result provided the inspection company 4. The data for evaluation requested to the data management company 1 is the equipment specification data, etc. The data for evaluation requested to the power company 2a is the up-to-date process data, the operation history data, etc. In response to this request, the power company 2a requests the data for evaluation (such as the up-to-date process data) to the data management company 1.

In response to the request from the plant maker 3a, the data management company 1 extracts the corresponding data for evaluation from among the equipment management data, and provides the extracted data for evaluation (such as the equipment specification data) to the plant maker 3a. Further, in response to the request from the power company 2a, the data management company 1 extracts the corresponding data for evaluation from among the equipment management data, and provides the extracted data for evaluation (such as the up-to-date process data) to the plant maker 3a.

The plant maker 3a executes the evaluation (diagnosis) of the equipment using the data for evaluation obtained from the data management company 1 and the power company 2a and the inspection result obtained from the inspection company 4. The plant maker 3a reports (provides) the inspection/evaluation results to the electric power company 2a, and charges the inspection/evaluation costs. Further, the plant maker 3a provides the inspection/evaluation results also to the data management company 1. The inspection/evaluation results are stored (additionally registered or updated) as the inspection data in the equipment-related database 23 of the data management company 1. If the evaluation result includes the trouble of the equipment (abnormal state), the evaluation result is stored as trouble data also in the equipment-related database 23 of the data management company 1.

Since the payment of the inspection/evaluation costs, the payment of the inspection cost, the request of the equipment repair/replacement, the report of the content of the equipment repair/replacement, the payment of the equipment repair/replacement, and the provision of the content of the equipment repair/replacement, etc. are the same as those in the first embodiment of FIG. 3, the explanation is omitted here.

In this embodiment, the charge of the data management cost and the report of the data management performance by the data management company 1 are different from those in the first embodiment. Namely, the data management company 1 reports the data management performance to both of the plant maker 3a and the power company 2a based on the data management contract, and charges the data management cost. The data management performance to the plant maker 3a includes the administration work such as the additional registration or the update of the data regarding the repair/replacement of equipment, and the inspection/evaluation results provided from the plant maker 3a. The data management performance to the power company 2a includes the administration work such as the additional registration of the process data provided from the power company 2a.

The plant maker 3a pays the data management cost to the data management company 1 in response to the charge from the data management company 1 based on the data management contract. Further, the power company 2a pays the data management cost to the data management company 1 in response to the charge from the data management company 1 based on the data management contract.

This embodiment also has substantially the same effects as the first embodiment. In this embodiment, the plant maker 3a may perform the inspection instead of the inspection company 4, and do the repair/replacement of equipment instead of the equipment maker 5.

(Fifth Embodiment)

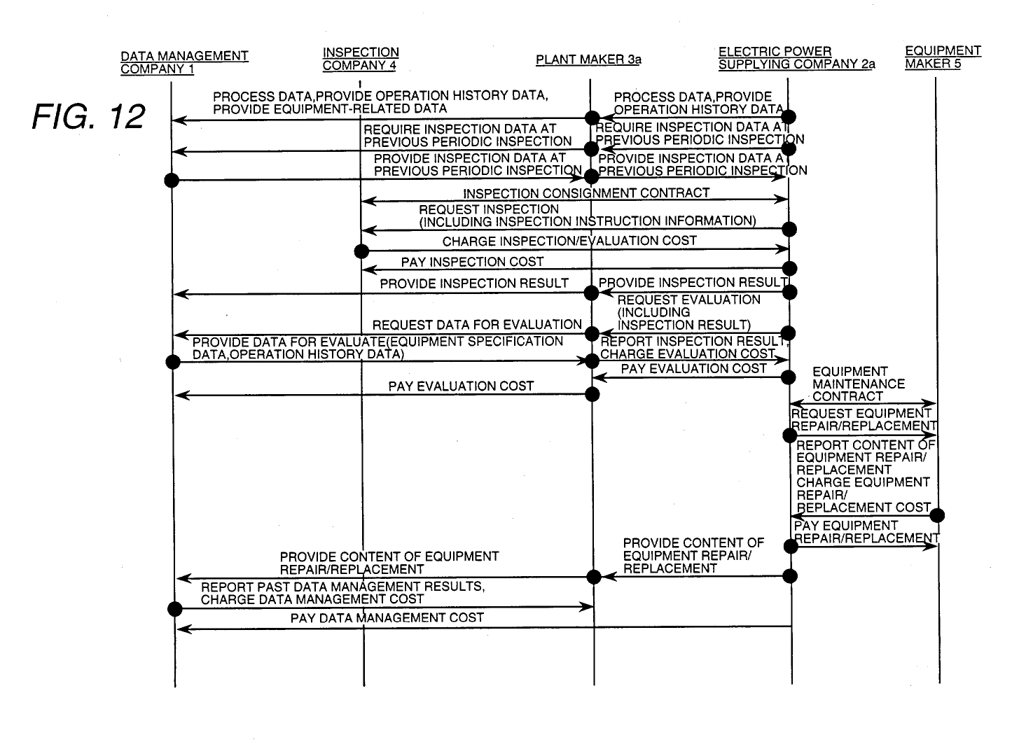

Next, a fifth embodiment in which the present invention is applied to an management business for the inspection data of equipment in a plant and operation data in the plant is explained by using FIG. 11 and FIG. 12. FIG. 11 is an illustration showing the contract mode relating to the management business according to the fifth embodiment. FIG. 12 is an outline business flow view relating to the management business according to the fifth embodiment.

In this embodiment, the data management company 1 concludes a data management contract with each of the plant maker 3a and 3b as shown in FIG. 11. The plant maker 3a and 3b conclude evaluation consignment contracts with the power company 2a and 2b, respectively. These contracts are yearly contracts, for example. This embodiment shows an example in which the power company having a plant requests the inspection of equipment to the inspection company, and does the evaluation of equipment to the plant maker.

The system configuration of the management business according to the present embodiment is the same as that of the first embodiment shown in FIG. 1. Further, also in this embodiment, the send and receive of data (information) between parties concerned is performed through the network 10 as the first embodiment, and the data received by each party concerned is stored in his/her server.

The features of the present embodiment resides in that when the send and receive of the data are performed between the power company and the data management company 1, the send and receive of the data is done through the plant maker. The management business according to the fifth embodiment is explained hereinafter with reference to FIG. 12. Although FIG. 12 shows the business flow between the power company 2a and plant maker 3a for the sake of simplicity, the business flow between the power company 2b and plant maker 3b is substantially the same. Even if the number of the power company and plant maker increases further, the business flow does not change.

Firstly, the power company 2a provides the process data and operation history data in the plant to the plant maker 3a based on the evaluation consignment contract. The data management company 1 acquires the process data, the operation history data, and the equipment-related data in the plant from the plant maker 3a based on the data management contract. These equipment management data (process data, operation history data, and equipment-related data) are stored in the equipment management database 100 of the data management company 1 every plant.

The above-mentioned description is the basic data registration in this business. Further, the process data of these basic data is always provided on-line from the electric power company 2 to the data management company 1, and stored as the latest data.

The electric power company 2a requests the inspection data at the previous periodic inspection to the plant maker 3a before requesting the inspection of equipment to the inspection company 4. The plant maker 3a, in response to the request from the power company 2a, requests the inspection data at the previous periodic inspection to the data management company 1. The data management company 1, in response to the request from the plant maker 3a, extracts the inspection data at the corresponding inspection date from among the equipment-related data, and provides said extracted inspection data at the previous periodic inspection to the plant maker 3a. The plant maker 3a provides the inspection data at the previous periodic inspection provided from the data management company 1 to the power company 2a.

Next, the power company 2a makes out an inspection schedule on the basis of the inspection data obtained from the plant maker 3a, and requests the inspection to the inspection company 4. At this time, the power company 2a provides inspection instruction information concerning the inspection schedule, the inspection specification and the record specification to the inspection company 4. The inspection company 4 carries out the inspection of equipment based on these inspection instruction information, and reports (provides) the inspection result and charges the inspection cost to the power company 2. The power company 2a judges whether or not the inspection result provided from the inspection company 4 is sufficient (suitable). If this judgment result is insufficient (unsuitable), the power company 2a requests again the inspection to the inspection company 4 (not shown).

If the above inspection result is sufficient, the power company 2 pays the inspection cost to the inspection company 4 in response to the charge from the inspection company 4. This inspection cost has predetermined depending on the conditions such as the inspection contents, the necessity of re-examination or the like. The payment condition of the inspection cost is specified in the inspection consignment contract between the power company 2a and the inspection company 4.

Also, If the above judgment result is sufficient, the power company 2a provides the inspection result to the plant maker 3a. The plant maker 3a the inspection result provided from the power company 2a to the data management company 1. This inspection result is stored (additionally registered or updated) in the equipment-related database 23 of the data management company 1 as inspection data.

Next, the power company 2a requests the evaluation (diagnosis) of the equipment by providing the inspection result to the plant maker 3a. The plant maker 3a requests the data for evaluation used for the evaluation of equipment to the data management company 1, in consideration of the inspection result. In response to this request, the data management company 1 extracts the corresponding data for evaluation from among the equipment management data, and provides the extracted data for evaluation to the plant maker 3a.

The plant maker 3a executes the evaluation (diagnosis) of the equipment using the data for evaluation obtained from the data management company 1 and the inspection result obtained from the power company 2a. The plant maker 3a reports (provides) the evaluation result to the electric power company 2a, and charges the evaluation cost. The electric power company 2a judges whether or not the evaluation result provided from the plant maker 3 is sufficient (suitable). If this judgment result is insufficient (unsuitable), the electric power company 2 requests re-evaluation (not shown).

If the above judgment result is sufficient (suitable), the electric power company 2a judges the necessity of equipment measures (the repair of equipment, the replacement, etc.) on the basis of the evaluation result provided from the plant maker 3a. Also, in case where the judgment results are sufficient, the electric power company 2a pays the evaluation cost to the plant maker 3a in response to the demand from the plant maker 3. This inspection cost has predetermined according to conditions such as the content of the evaluation, the existence of the re-evaluation or the like in the data management contract.

Further, the plant maker 3a provides the evaluation result also to the data management company 1. The evaluation result is stored (additionally registered or updated) in the equipment-related database 23 of the data management company 1 as the inspection data. If the evaluation result includes the trouble of equipment (abnormal state), the evaluation result is stored in the equipment-related database 23 of the data management company 1 also as trouble data.

If the electric power company 2a judged that there is necessity of the equipment measures, the electric power company 2 requests the equipment repair/replacement to the equipment maker 5. The equipment maker 5 performs the repair/replacement of the equipment in response to the request, and reports (provides) the contents of equipment repair/replacement to the power company 2a. Further, the equipment maker 5 charges the repair/replacement costs to the power company 2a.

The electric power company 2a judges whether or not the content of the equipment repair/replacement provided from the equipment maker 5 is sufficient (suitable). If this judgment result shows insufficiency (inadequacy), the electric power company 2a requests again the equipment repair/replacement to the equipment maker 5 (not shown). If the judgment result shows sufficiency, the electric power company 2 pays the equipment repair/replacement costs to the equipment maker 5, in answer to the charge from the equipment maker 5. This repair/replacement cost of the equipment has been predetermined according to the conditions such as the content of the equipment repair/replacement, the presence of the re-order and the like.

Further, if the judgment result is sufficient, the power company 2a provides the contents of the equipment repair/replacement to the plant maker 3a. The plant maker 3a provides the contents of the equipment repair/replacement provided from the power company 2a to the data management company 1. This contents of the equipment repair/replacement is stored (additionally registered or updated) in the operation history database 22 of the data management company 1 as the maintenance history data (operation history data) of the equipment.

The data management company 1 reports the data administration performance to the plant maker 3a on the basis of the data administration contract, and charges the data administration cost. This data administration performance includes administration work such as the additional registration or update, etc. of data regarding the content of the equipment repair/replacement, the inspection result, the evaluation result and the process data provided from the plant maker 3a. The plant maker 3a pays the data administration cost to the data management company 1 in response to the charge from the data management company 1.

This embodiment also has substantially the same effects as the first embodiment. In this embodiment, the data management contract can be concluded so that the process data may be provided directly from the power company 2a to the data management company 1. Further, the power company 2a may perform the inspection instead of the inspection company 4, and do the repair/replacement of equipment instead of the equipment maker 5.

Although the example in which the present invention is applied to the data management business in the nuclear power plant has been explained in the above embodiments, the same effects may be obtained in the example in which the present invention is applied to the data management business in the thermal power plant.

What is claimed is:

1. A data administration method in a power-generating plant wherein:
process data and operation history data of the power-generating plant are acquired from an electric power company concluding a data administration contract; equipment-related data including the inspection data of the configuration equipment of a plant is acquired from a plant maker concluding a data administrating contract; and these data are stored in a memory device in the state related to said plant configuration equipment and/or inspection date every power-generating plant which said electric power company stores:
the inspection data of the corresponding inspection data from among data stored in said memory device is extracted in response to inspection data requirement from said plant maker, and the extracted inspection data is provided to said plant maker; and
in response to the data requirement necessary for the evaluation of said plant configuration equipment from said plant maker, data necessary for said evaluation from among the data stored in said memory device; and the data necessary for the evaluation which was extracted is provided to said plant maker.

2. A data administration method in a power-generating plant wherein:
process data and operation history data of the power-generating plant are acquired from an electric power company concluding a data administration contract; equipment-related data including the inspection data of the configuration equipment of a plant is acquired from a plant maker concluding a data administrating contract; and these data are stored in a memory device in the state related to said plant configuration equipment and/or inspection date every power-generating plant which said electric power company stores:
the inspection data of the corresponding inspection data from among data stored in said memory device is extracted in response to inspection data requirement from said plant maker, and the extracted inspection data is provided to said plant maker; and
in response to the data requirement necessary for the evaluation of said plant configuration equipment from said plant maker and said electric power generating company, data necessary for said evaluation from among the data stored in said memory device; and the data necessary for the evaluation which was extracted is provided to said plant maker and said electric power company.

3. A data administration method in a power-generating plant wherein:
process data and operation history data of the power-generating plant, and equipment-related data including the inspection data of the configuration equipment of a plant are acquired from an electric power company concluding a data administration contract; equipment-related data including the inspection data of the configuration equipment of a plant is acquired from a plant maker concluding a data administrating contract; and these data are stored in a memory device in the state related to said plant configuration equipment and/or inspection date every power-generating plant which said electric power company stores:
the inspection data of the corresponding inspection data from among data stored in said memory device is extracted in response to inspection data requirement from said plant maker, and the extracted inspection data is provided to said plant maker; and
in response to the data requirement necessary for the evaluation of said plant configuration equipment from said plant maker, data necessary for said evaluation from among the data stored in said memory device; and the data necessary for the evaluation which was extracted is provided to said plant maker.

4. A data administration method in a power-generating plant according to any one of claims 1 to 3, wherein:
the data necessary for said evaluation includes data relating to the plant configuration equipment of another power-generating plant corresponding to the plant configuration equipment which is an evaluation object.

5. A data administration method in a power-generating plant according to claim 4, wherein:
the data relating to the plant configuration equipment of said other power-generating plant includes al least one of the inspection data and the maintenance history data.

6. A data administration method in a power-generating plant according to any one of claims 1 to 5, wherein:
the inspection result and evaluation result newly provided from said plant maker are stored in said memory device as new inspection data in the state related to the corresponding power-generating plant, plant configuration equipment and inspection date.

7. A data administration method in a power-generating plant according to any one of claims 1 to 7, wherein:
the maintenance content of said plant configuration equipment newly provided said plant maker is stored in the state related to the corresponding power-generating plant, plant configuration equipment and inspection date.

8. A data administration method in a power-generating plant according to any one of claims 1 to 7, wherein:
the data administration performance is reported to said plant maker.

9. A data administration method in a power-generating plant wherein:
process data and operation history data of the power-generating plant are acquired from an electric power company concluding a data administration contract; equipment-related data including the inspection data of the configuration equipment of a plant is acquired from a plant maker concluding a data administrating contract; and these data are stored in a memory device in the state related to said plant configuration equipment and/or inspection date every power-generating plant which said electric power company stores:
the inspection data of the corresponding inspection data from among data stored in said memory device is extracted in response to inspection data requirement from said plant maker, and the extracted inspection data is provided to said electric power company; and
in response to the data requirement necessary for the evaluation of said plant configuration equipment from said plant maker, data necessary for said evaluation from among the data stored in said memory device; and the data necessary for the evaluation which was extracted is provided to said plant maker.

10. A data administration method in a power-generating plant wherein:
process data and operation history data of the power-generating plant, and equipment-related data including the inspection data of the configuration equipment of a plant are acquired from a plant maker concluding a data administration contract; equipment-related data including the inspection data of the configuration equipment of a plant is acquired from a plant maker concluding a data administrating contract; and these data are stored in a memory device in the state related to said plant configuration equipment and/or inspection date every power-generating plant which said electric power company stores:
the inspection data of the corresponding inspection data from among data stored in said memory device is extracted in response to inspection data requirement from said electric power company, and the extracted inspection data is provided to said electric power company; and
in response to the data requirement necessary for the evaluation of said plant configuration equipment from said electric power company, data necessary for said evaluation from among the data stored in said memory device; and the data necessary for the evaluation which was extracted is provided to said electric power company.

11. A data administration method in a power-generating plant according to claims 9 or 11, wherein:
the data necessary for said evaluation includes data relating to the plant configuration equipment of another power-generating plant corresponding to the configuration equipment of a plant which is an evaluation object.

12. A data administration method in a power-generating plant according to claim 11, wherein:
the data relating to the plant configuration equipment of said other power-generating plant includes al least one of the inspection data and the maintenance history data.

13. A data administration method in a power-generating plant according to any one of claims 9 to 12, wherein:
the inspection result and evaluation result newly provided from said plant maker are stored in said memory device as new inspection data in the state related to the corresponding power-generating plant, plant configuration equipment and inspection date.

14. A data administration method in a power-generating plant according to any one of claims 9 to 13, wherein:
the maintenance content of said plant configuration equipment newly provided said plant maker is stored in the state related to the corresponding power-generating plant, plant configuration equipment and inspection date.

15. A data administration method in a power-generating plant according to any one of claims 9 to 14, wherein:
the data administration performance is reported to said plant maker.

16. A data administration method in a power-generating plant according to any one of claims 1 to 14, wherein:
said equipment-related data includes the inspection data, design data, disadvantage data of said plant configuration equipment.
